(19) United States
(12) Patent Application Publication
(10) Pub. No.: US 2005/0202986 A1
(43) Pub. Date: Sep. 15, 2005

(54) Compositions for solubilizing lipids

(76) Inventors: Zhenze Hu, Pittsford, NY (US); Joseph C. Salamone, Fairport, NY (US)

Correspondence Address: Bausch & Lomb Incorporated, One Bausch & Lomb Place, Rochester, NY, 14604-2701, US

(21) Appl. No.: 10/799,522

(22) Filed: Mar. 12, 2004

(51) Int. Cl. B05D 3/00; C11D 1/00

(52) U.S. Cl. 510/161; 427/2.1; 427/164

(57) ABSTRACT

Compositions and methods for cleaning contact lenses employing nonionic surfactants having HLBs greater than about 18 with the nonionic surfactant having a greater HLB present in an amount about twice that of the nonionic surfactant having a lower HLB, and provided in an amount effective to reduce the amount of lipids on the contact lenses, thus rendering the contact lenses easier to clean. Additionally, by soaking contact lenses in the composition prior to inserting the lens on the eye, the compositions provide a prophylactic effect in preventing lipid deposition while the contact lens is worn.

### FIELD OF THE INVENTION

The present invention is directed toward a relatively mild composition for solubilizing lipids. Surprisingly, it has been discovered that the use of Tetronic 1107™ (BASF, Mount Olive, N.J.) and Pluronic F127™ (BASF) at a weight ratio of about 2:1 in lipid solubilizing compositions is more effective in solubilizing lipids than use thereof at other weight ratios. Compositions of the present invention including Tetronic 1107™ and Pluronic F127™ at a weight ratio of about 2:1 are useful for medical applications such as cleaning of body tissues and medical devices soiled with lipids. Such is particularly useful for cleaning silicone hydrogel high-Dk lenses. Formulations based on the subject invention are so mild that they can be used directly in or on the human body in situ.

### BACKGROUND OF THE INVENTION

Conventionally, contact lenses have been classified into water-nonabsorptive contact lenses and water-absorptive contact lenses, and classified into hard contact lenses and soft contact lenses. Both hard and soft contact lenses may develop deposits or a stain of lipids derived from tears while the lens is worn in the eye. Such lipid stains may cause deterioration in the comfort of a lens during wear or cause eye problems such as blurred eyesight or congestion of the cornea. Accordingly, it is essential to apply a cleaning treatment to a contact lens in order to safely and comfortably use contact lenses every day.

To effectively clean contact lenses, solutions formulated for cleaning contact lenses having cleaning or removal effect over one or more stains are typically used. Solutions formulated for cleaning contact lenses may include therein a surfactant useful as a cleaning component. Contact lens cleaning solutions incorporating nonionic surfactants such as a polyoxyalkylene block copolymer such as a polyoxyethylene-polyoxypropylene block copolymer or a derivative thereof are known.

However, cleaning solutions for contact lenses containing nonionic surfactants may risk causing eye irritation. Great importance is attached to the safety and comfort of lens care solutions, thus requiring the concentration of cleaning surfactants, if any in the solution, to be maintained as low as possible. Experience shows that conventional cleaning solutions for contact lenses containing cleaning surfactants at low concentrations to avoid eye discomfort or irritation, lack adequate cleaning power or lipid-solubilizing power. As a result, cleaning treatments of contact lenses using a low concentration surfactant cleaning solution, tend to allow lipid stains to remain and accumulate on the contact lens, potentially being harmful to the eye.

U.S. Pat. No. 5,500,144 (Potini et al.), discloses compositions for the care of contact lenses including a silicone polymer containing an alkyleneoxide side chain. Included in the silicone polymer compositions are nonionic surface-active agents having good cleaning activity, such as polyoxyethylene, polyoxypropylene block copolymers having hydrophilic/lipophilic balances (HLBs) of generally about 12 to about 18, as opposed to other poloxamers that may also be employed in the compositions as primary cleaning agents having HLBs of at least about 18.

U.S. Pat. No. 6,417,144 (Tsuzuki et al.) discloses a solution for contact lenses comprising the combination of an amino acid type cationic surfactant and at least one nonionic surfactant with an HLB above 18 whereby cleaning powers are synergistically increased over the use of either an amino acid type cationic surfactant or a nonionic surfactant independently.

U.S. patent application Ser. No. 10/724,797 teaches a no-rub and no-rinse contact lens cleaning and disinfecting solution including one or more polymeric surfactants having a HLB of 20 or greater.

U.S. patent application Ser. No. 10/724,679 teaches the use of one or more nonionic polyether surfactants having a HLB less than 12 in an amount effective to remove lipid deposits from surfaces of a contact lens.

As mentioned above, nonionic surfactants are well known in the art of contact lens cleaning. However independent use of nonionic surfactants for cleaning contact lenses appear to have considerable limitations in cleaning effectiveness at low concentrations and are known to potentially cause ocular irritation at higher concentrations. Accordingly, it would be desirable to find a contact lens cleaning solution effective in removing lipid stains without causing ocular irritation.

### SUMMARY OF THE INVENTION

The present invention provides compositions that include Tetronic 1107™ having a hydrophilic/lipophilic balance (HLB) of 24 and Pluronic F127™ having a HLB of 22 in a ratio of 2:1 in an effective amount for removing, reducing and/or preventing lipid deposits on medical devices such as but not limited to contact lenses, and bodily tissues. Also, methods for removing lipid deposits from surfaces of contact lenses and for preventing or reducing the amount of such deposits thereon are provided. One method of the present invention comprises soaking a contact lens in an aqueous composition comprising two nonionic polyether surfactants each having HLBs greater than about 18, with the nonionic polyether surfactant having the greater HLB present in an amount about twice that of the nonionic polyether surfactant having the lower HLB, in an amount effective to reduce the formation of lipid deposits on the contact lens.

Another method of the present invention comprises soaking a contact lens in an aqueous composition comprising two nonionic polyether surfactants each having HLBs greater than about 18, with the nonionic polyether surfactant having the greater HLB present in an amount about twice that of the nonionic polyether surfactant having the lower HLB, in an amount effective to remove lipid deposits from surfaces of the contact lens. According to various preferred embodiments, lipid deposits can be removed from surfaces of a contact lens without manual rubbing of the lens, for example, by rinsing.

Still another method of the present invention comprises preventing deposition of lipids on a contact lens while worn on the eye. This method comprises soaking the contact lens in an aqueous composition, and inserting the contact lens in the eye without rinsing the composition from the contact lens, or instilling one or more drops of the composition in the eye while wearing the contact lens, wherein the composition comprises two nonionic polyether surfactants each having HLBs greater than about 18, with the nonionic polyether surfactant having the greater HLB present in an amount about twice that of the nonionic polyether surfactant having the lower HLB, in an amount effective to prevent deposition of lipids on a contact lens while worn in the eye.

### BRIEF DESCRIPTION OF THE DRAWINGS

FIG. 1 is a graph of lipid cleaning (absorbance at 485.5 nm) vs. concentration of nonionic polyether surfactant; and

FIG. 2 is a graph illustrating the effect of the weight ratio of Tetronic 1107™ to Pluronic F127™ on the lipid cleaning (absorbance at 486 nm) efficacy.

### DETAILED DESCRIPTION OF THE INVENTION

Compositions of the present invention may be used with all contact lenses such as conventional hard, soft, rigid and soft gas permeable, and silicone (including both hydrogel and non-hydrogel) lenses, but is preferably employed with soft hydrogel lenses. Such lenses are commonly prepared from hydrophilic monomers such as 2-hydroxyethyl (meth)acrylate, N-vinylpyrrolidone, glycerol (meth)acrylate, and (meth)acrylic acid. In the case of silicone hydrogel lenses, a silicone-containing monomer is copolymerized with at least one hydrophilic monomer. Such lenses absorb significant amounts of water, typically from 10 to 80 percent by weight, and especially 20 to 70 percent water.

Compositions employed in this invention are aqueous solutions. The compositions include, as essential components, two differing nonionic polyether surfactants having HLBs greater than 18 in a weight ratio of higher HLB surfactant to lower HLB surfactant of about 2:1. If both surfactants have the same HLB, preferably the weight ratio of higher molecular weight surfactant to lower molecular weight surfactant is about a 2:1 ratio. Many nonionic polyether surfactants comprise one or more chains or polymeric components having oxyalkylene (—O—R—) repeats units wherein R has 2 to 6 carbon atoms. Representative nonionic polyether surfactants comprise block polymers of two or more different kinds of oxyalkylene repeat units, the ratio of which determining the HLB of the surfactant. Examples of such poloxamers are polyoxyethylene, polyoxypropylene block copolymers available under the trade name Pluronic™ (BASF). Poloxamines are ethylene diamine adducts of such polyoxyethylene, polyoxypropylene block copolymers available under the trade name Tetronic™ (BASF), including for example poloxamine 1107 (Tetronic 1107™) having a molecular weight from about 7,500 to about 27,000 wherein at least 40 weight percent of said adduct is poly(oxyethylene) having a HLB of 24. Suitable nonionic polyether surfactants for use in compositions of the present invention include for example but are not limited to Pluronic F38™ (BASF) having a HLB of 31 and average molecular weight (AMW) of 4700, Pluronic F68™ (BASF) having a HLB of 29 and AMW of 8400, Pluronic 68LF™ (BASF) having a HLB of 26 and AMW or 7700, Pluronic F77™ (BASF) having a HLB of 25 and AMW of 6600, Pluronic F87™ (BASF) having a HLB of 24 and AMW of 7700, Pluronic F88™ (BASF) having a HLB of 28 and AMW or 11400, Pluronic F98™ (BASF) having a HLB of 28 and AMW of 13000, Pluronic F108™ (BASF) having a HLB of 27 and AMW of 14600, Pluronic F127™ (BASF) having a HLB of 22 and AMW of 12600, Pluronic L35™ (BASF) having a HLB of 19 and AMW of 1900, Tetronic 707™ (BASF) having a HLB of 27 and AMW of 12200, Tetronic 908™ (BASF) having a HLB of 31 and AMW of 25000, Tetronic 909™ (BASF) having a HLB of 32 and AMW of 30000, Tetronic 1107™ (BASF) having a HLB of 24 and AMW of 15000, Tetronic 1307™ (BASF) having a HLB of 24 and AMW of 18000, and Tetronic 1508™ (BASF) having a HLB of 27 and AMW of 30000.

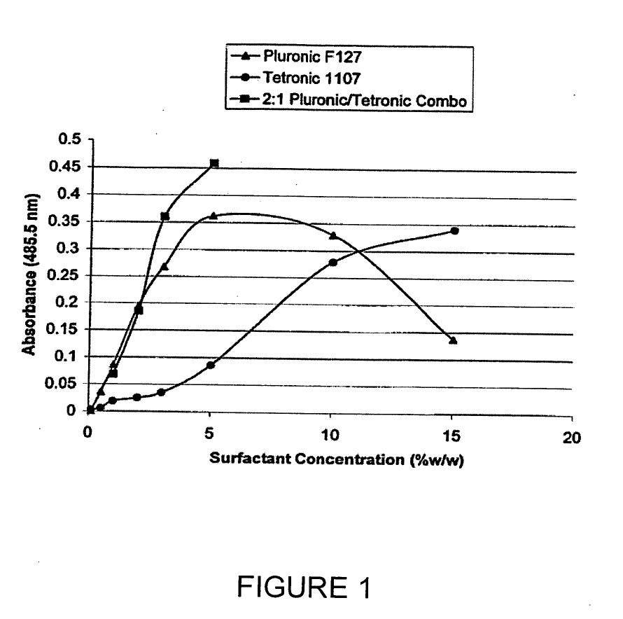

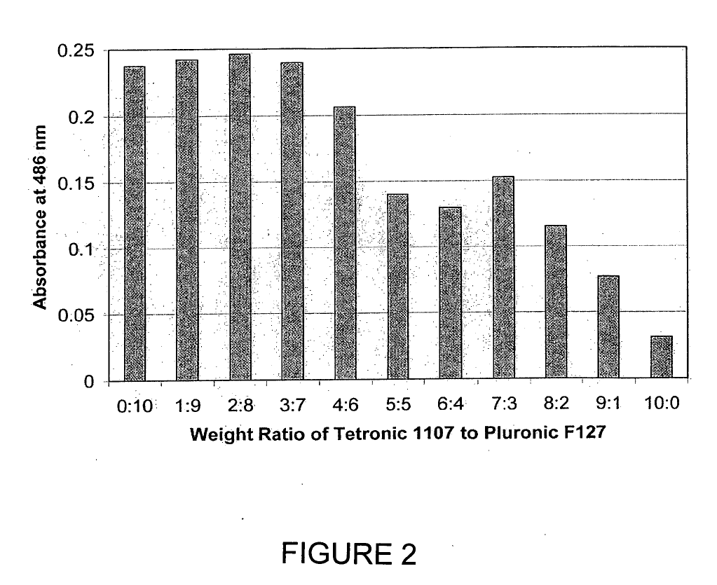

Relatively high HLB values greater than about 18, or even more preferably 22 or higher, indicate a lower affinity for both hydrophobic molecules and/or surfaces, such as lipids and hydrophilic molecules. Relatively high HLB nonionic polyether surfactants used in combination in about a 2:1 ratio as described above, have been found to significantly decrease lipid affinity to the surface of contact lenses as illustrated in FIGS. 1 and 2, and are effective in removing lipids from the surface of contact lenses without mechanical or digital cleaning. Such nonionic polyether surfactants are preferably employed in compositions of the present invention in total combined amounts ranging from about 0.1 to about 6.0 weight percent, more preferably from about 0.2 to about 5.0 weight percent to achieve cleaning efficacy.

According to various preferred embodiments of the present invention, the subject compositions are likewise suitable for disinfecting a contact lens soaked therein. In addition to water, it is preferred that the subject compositions also include at least one antimicrobial agent, especially a non-oxidative antimicrobial agent that derives its antimicrobial activity through a chemical or physicochemical interaction with organisms. So that the contact lenses treated with the composition may be instilled directly in the eye, i.e., without rinsing the contact lens with a separate composition, the antimicrobial agent needs to be an ophthalmically acceptable antimicrobial agent.

Suitable antimicrobial agents for use in the present invention include quaternary ammonium salts which do not include significant hydrophobic portions, e.g., alkyl chains comprising more than six carbon atoms. Suitable quaternary ammonium salts for use in the present invention include for example but are not limited to poly[(dimethyliminio)-2-butene-1,4-diyl chloride] and [4-tris(2-hydroxyethyl) ammonio]-2-butenyl-ω-[tris(2-hydroxyethyl)ammonio] dichloride (Chemical Abstracts Registry Number 75345-27-6) generally available as Polyquaternium 1 (Onyx Corporation, Montpelier, Vt.). Also suitable are biguanides and their salts, such as 1,1′-hexamethylene-bis[5-(2-ethylhexyl)biguanide] (Alexidine) and poly(hexamethylene biguanide) (PHMB) available from ICI Americas, Inc., Wilmington Del. under the trade name Cosmocil CQ, benzalkonium chloride (BAK) and sorbic acid.

One or more antimicrobial agents are present in the subject compositions in an amount effective for disinfecting a contact lens, as found in conventional lens soaking and disinfecting solutions. Preferably, the antimicrobial agent will be used in a disinfecting amount or an amount from about 0.0001 to about 0.5 weight percent by volume. A disinfecting amount of an antimicrobial agent is an amount that will at least partially reduce the microorganism population in the formulations employed. Preferably, a disinfecting amount is that which will reduce the microbial burden by two log orders in four hours and more preferably by one log order in one hour. Most preferably, a disinfecting amount is an amount that will eliminate the microbial burden on a contact lens when used in the regimen for the recommended soaking time (FDA Chemical Disinfection Efficacy Test—July 1985 Contact Lens Solution Draft Guidelines). Typically, such agents are present in concentrations ranging from about 0.00001 to about 0.5 weight percent based on volume (w/v), and more preferably, from about 0.00003 to about 0.05 weight percent.

Compositions of the present invention may also contain various other components including for example but not limited to one or more chelating and/or sequestering agents, one or more osmolality adjusting agents, one or more surfactants, one or more buffering agents and/or one or more wetting agents.

Chelating agents, also referred to as sequestering agents, are frequently employed in conjunction with an antimicrobial agent. These agents bind heavy metal ions, which might otherwise react with the lens and/or protein deposits and collect on the lens. Chelating agents are well known in the art, and examples of preferred chelating agents include ethylenediaminetetraacetic acid (EDTA) and its salts, especially disodium EDTA. Such agents are normally employed in amounts from about 0.01 to about 2.0 weight percent, more preferably from about 0.01 to about 0.3 weight percent. Other suitable sequestering agents include gluconic acid, citric acid, tartaric acid and their salts, e.g., sodium salts.

Compositions of the present invention may be designed for a variety of osmolalities, but it is preferred that the compositions are iso-osmal with respect to eye fluids. Specifically, it is preferred that the compositions have an osmotic value of less than about 350 mOsm/kg, more preferably from about 175 to about 330 mOsm/kg, and most preferably from about 260 to about 310 mOsm/Kg. One or more osmolality adjusting agents may be employed in the composition to obtain the desired final osmolality. Examples of suitable osmolality adjusting agents include, but are not limited to sodium and potassium chloride, monosaccharides such as dextrose, calcium and magnesium chloride, and low molecular weight polyols such as glycerin and propylene glycol. Typically, these agents are used individually in amounts ranging from about 0.01 to 5 weight percent and preferably, from about 0.1 to about 2 weight percent.

Compositions of the present invention have an ophthalmically compatible pH, which generally will range between about 6 to about 8, and more preferably between 6.5 to 7.8, and most preferably about 7 to 7.5. One or more conventional buffers may be employed to obtain the desired pH value. Suitable buffers include for example but are not limited to borate buffers based on boric acid and/or sodium borate, phosphate buffers based on Na₂HPO₄, NaH₂PO₄ and/or KH₂PO₄, citrate buffers based on sodium or potassium citrate and/or citric acid, sodium bicarbonate, aminoalcohol buffers and combinations thereof. Generally, buffers will be used in amounts ranging from about 0.05 to about 2.5 weight percent, and preferably, from about 0.1 to about 1.5 weight percent.

The subject compositions may likewise include a wetting agent, to facilitate the composition wetting the surface of a contact lens. Within the art, the term “humectant” is also commonly used to describe these materials. A first class of wetting agents are polymer wetting agents. Examples of suitable wetting agents include for example but are not limited to poly(vinyl alcohol) (PVA), poly(N-vinylpyrrolidone) (PVP), cellulose derivatives and poly(ethylene glycol). Cellulose derivatives and PVA may be used to also increase viscosity of the composition, and offer this advantage if desired. Specific cellulose derivatives include for example but are not limited to hydroxypropyl methyl cellulose, carboxymethyl cellulose, methyl cellulose, hydroxyethyl cellulose, and cationic cellulose derivatives. As disclosed in U.S. Pat. No. 6,274,133, cationic cellulosic polymers also help prevent accumulation of lipids and proteins on a hydrophilic lens surface. Such cationic cellulosic polymers include for example but are not limited to water soluble polymers commercially available under the CTFA (Cosmetic, Toiletry, and Fragrance Association) designation Polyquaternium-10, including the cationic cellulosic polymers available under the trade name UCARE® Polymers from Amerchol Corp., Edison, N.J., such as for example but not limited to Polymer JR™. Generally, these cationic cellulose polymers contain quaternized N,N-dimethylamino groups along the cellulosic polymer chain.

Another suitable class of wetting agents is non-polymeric wetting agents. Examples include glycerin, propylene glycol, and other non-polymeric diols and glycols.

The specific quantities of wetting agents used in the present invention will vary depending upon the application. However, the wetting agents will typically be included in an amount from about 0.01 to about 5 weight percent, preferably from about 0.1 to about 2 weight percent.

It will be understood that some constituents possess more than one functional attribute. For example, cellulose derivatives are suitable polymeric wetting agents, but are also referred to as “viscosity increasing agents” to increase viscosity of the composition if desired. Glycerin is a suitable non-polymeric wetting agent but is also may contribute to adjusting tonicity.

Compositions of the present invention may also include one or more ophthalmically acceptable surfactant, which may be either cationic, anionic, nonionic or amphoteric. Preferred surfactants are amphoteric or nonionic surfactants. The surfactant should be soluble in the aqueous solution and non-irritating to eye tissues. The surfactant serves mainly to facilitate removal of non-proteinaceous matter on the contact lens.

Suitable nonionic surfactants include for example but are not limited to polyethylene glycol esters of fatty acids, e.g. coconut, polysorbate, polyoxyethylene or polyoxypropylene ethers of higher alkanes (C₁₂-C₁₈), polysorbate 20 available under the trade name Tween® 20 (ICI Americas, Inc., Wilmington, Del.), polyoxyethylene (23) lauryl ether available under the trade name Brij® 35 (ICI Americas, Inc.), polyoxyethyene (40) stearate available under the trade name Myrj® 52 (ICI Americas, Inc.) and polyoxyethylene (25) propylene glycol stearate available under the trade name Atlas® G 2612 (ICI Americas, Inc.).

Another useful class of cleaning agents are the hydroxyalkylphosphonates, such as those disclosed in U.S. Pat. No. 5,858,937 (Richards et al.), and available under the trade name Dequest® (Montsanto Co., St. Louis, Mo.).

Amphoteric surfactants suitable for use in a composition according to the present invention include materials of the type are offered commercially under the trade name Miranol™ (Noveon, Inc., Cleveland, Ohio). Another useful class of amphoteric surfactants is exemplified by cocoamidopropyl betaine, commercially available from various sources.

Various other ionic as well as amphoteric and anionic surfactants suitable for in the invention can be readily ascertained, in view of the foregoing description, from McCutcheon's Detergents and Emulsifiers, North American Edition, McCutcheon Division, MC Publishing Co., Glen Rock, N.J. 07452 and the CTFA International Cosmetic Ingredient Handbook, Published by The Cosmetic, Toiletry, and Fragrance Association, Washington, D.C.

Preferably, the surfactants, when present, are employed in a total amount from about 0.01 to about 15 weight percent, preferably about 0.1 to about 9.0 weight percent, and most preferably about 0.1 to about 7.0 weight percent.

As an illustration of the present invention, several examples are provided below. These examples serve only to further illustrate aspects of the invention and should not be construed as limiting the invention.

### EXAMPLE 1

### Preparation of Test Solution

A multipurpose lens care sample solution for testing was prepared in accordance with the formulation set forth below in Table 1.

TABLE 1
MULTIPURPOSE LENS CARE TEST SOLUTION

| Ingredients % W/W | Test Solution 1 |
|---|---|
| Pluronic P127 | 2.00 |
| Tetronic 1107 | 1.00 |
| Sodium Phosphate Monobasic | 0.15 |
| Sodium Phosphate Dibasic | 0.31 |
| Boric Acid | 0.85 |
| PHMB (ppm) | 1.1 |
| Sodium Chloride | 0.26 |
| Dequest ™ 2016 (30%) | 0.1 |
| Polyquaternium 10 | 0.02 |
| pH | 7.0 |
| Osmolality (mOsm/Kg) | 300 |

Dequest ™ 2016 = diphosphonic acid sodium salt
PHMB = poly(hexamethylene biguanide)

### EXAMPLE 2

### Preparation of Test Solution

A lens drops sample solution for testing was prepared in accordance with the formulation set forth below in Table 2.

TABLE 2
LENS DROPS TEST SOLUTION

| Ingredients % W/W | Test Solution 2 |
|---|---|
| Pluronic P127 | 2.00 |
| Tetronic 1107 | 1.00 |
| Tromethamine | 0.121 |
| Sodium Borate | 0.134 |
| EDTA-Na | 0.05 |
| Glycerin | 1.0 |
| Sodium Chloride | 0.38 |
| Sorbic Acid | 0.165 |
| Polymer JR ™ | 0.02 |
| pH | 7.0 |
| Osmolality (mOsm/Kg) | 305 |

EDTA = ethylenediamine tetraacetic acid

### EXAMPLE 3

### Cleaning Effect of Test Solutions

The cleaning effect of several test solutions over lipids was examined by means of a lipid-solubilizing rate method. Specifically, the lipids, C₁₀₋₃₀ cholesterol/lanosterol esters, available under the trade name Super Sterol Ester™ from Croda Incorporated, Parsippany, N.J., and a dye material, available under the trade name Sudan I™ from Aldrich Chemical Company, Milwaukee, Wis., were used to produce a lipid solution used in determining the lipid cleaning efficacy of several test solutions. The lipid solution was produced by heating 9.9 grams of super sterol ester until melted. Once melted, 0.1 gram of Sudan I was added and mixed well. The mixture was a homogeneous red wax at room temperature that liquefied with slight heating. Into glass test tubes, five drops of liquefied lipid solution was placed making sure all drops coherently collected. Once the lipid solution in the test tubes cooled to room temperature, the tubes were ready for testing. Five ml of test solution was added to a test tube containing room temperature lipid solution and agitated for 24 hours at 150 revolutions per minute (RPM) at room temperature. Supernatant fluid from each test tube was collected and the absorbance at 485.5 was measured by a spectrophotomer (Shimadzu Corporation, Kyoto, Japan). Lipid solubilization was estimated by intensity of the red color of Sudan I at 485.5 nm. The higher the intensity, the more effective the test solution at solubilizing the lipids. Test results are set forth below in Tables 3 and 4.

TABLE 3
Multipurpose Lens Care Solution Comparative Study Results

| Test Solution | Lipid Solubilization |
|---|---|
| Test Solution 1 | 0.493 |
| ReNu MultiPlus ™ | 0.011 |
| Solocare PIus ™ | 0.063 |
| Optifree Express ™ | 0.026 |

ReNu MuItiPIus ™ (Bausch & Lomb Incorporated, Rochester, New York)
Solocare Plus ™ (Ciba Vision Corporation, Duluth, Georgia)
Optifree Express ™ (Alcon Laboratories, Fort Worth, Texas)

TABLE 4
Lens Drops Comparative Study Results

| Test Solution | Lipid Solubilization |
|---|---|
| Test Solution 2 | 0.250 |
| Visine ™ for contact lenses | 0.012 |
| Clerz ™ | 0.122 |
| Blink-n-Clean ™ | 0.016 |

Visine ™ (Pfizer, New York, New York)
Clerz ™ (Alcon Laboratories, Fort Worth, Texas)
Blink-n-Clean ™ (Allergan, Irvine, California)

Compositions of the present invention may be used for soaking a contact lens whereby the aqueous composition comprises two differing nonionic polyether surfactants having a HLB greater than 18 in a 2:1 ratio as described above and in an amount effective to reduce the formation of lipid deposits on the contact lens.

Compositions of the present invention may also be used for rinsing or soaking a contact lens whereby the aqueous composition comprises two differing nonionic polyether surfactants having a HLB greater than 18 in a 2:1 ratio as described above and in an amount effective to remove lipid deposits from surfaces of the contact lens.

Still another method of using compositions of the present invention comprises preventing deposition of lipids on a contact lens while worn on the eye. This method comprises soaking the contact lens in an aqueous composition with two differing nonionic polyether surfactants having a HLB greater than 18 in a 2:1 ratio as described above and present in an effective amount to reduce the formation of lipid deposits on the contact lens, and inserting the contact lens in the eye without rinsing the composition from the contact lens, or instilling one or more drops of the composition in the eye while wearing the contact lens, to prevent deposition of lipids on a contact lens while worn in the eye.

Although various preferred embodiments have been illustrated, many other modifications and variations of the present invention are possible to the skilled practitioner. It is therefore understood that, within the scope of the claims, the present invention can be practiced other than as herein specifically described.

1. A composition for preventing, removing or reducing the formation of lipid deposits on a medical device comprising:
two nonionic surfactants having HLBs greater than about 18 with said nonionic surfactant having a greater HLB present in an amount about twice that of said nonionic surfactant having a lower HLB.

2. A composition for preventing, removing or reducing the formation of lipid deposits on a medical device comprising:
two nonionic surfactants having equal HLBs greater than about 18 with said nonionic surfactant having a greater average molecular weight present in an amount about twice that of said nonionic surfactant having a lower average molecular weight.

3. A composition for treating lipid deposits on a medical device comprising:
two nonionic surfactants having HLBs greater than about 18 with said nonionic surfactant having a greater HLB present in an amount about twice that of said surfactant having a lower HLB, wherein said surfactants are present in an effective amount for removing, reducing or preventing lipid deposits on said medical device.

4. A composition for preventing, removing or reducing the formation of lipid deposits on a medical device comprising:
poloxamine and poloxamer surfactants having HLBs greater than about 18 with said poloxamine surfactant present in an amount about twice that of said poloxamer surfactant.

5. The composition of claim 1, 2, 3 or 4 wherein said medical device is a contact lens.

6. The composition of claim 1, 2 or 3 wherein said two nonionic surfactants are nonionic polyether surfactants

7. The composition of claim 1, 2 or 3 wherein said two nonionic surfactants are selected from the group consisting of Pluronic F38™, Pluronic F68™, Pluronic 68LF™, Pluronic F77™, Pluronic F87™, Pluronic F88™, Pluronic F98™, Pluronic F108™, Pluronic F127™, Pluronic L35™, Tetronic 707™, Tetronic 908™, Tetronic 909™, Tetronic 1107™, Tetronic 1307™, and Tetronic 1508™.

8. The composition of claim 4 wherein said poloxamine and poloxamer surfactants are selected from the group consisting of Pluronic F38™, Pluronic F68™, Pluronic 68LF ™, Pluronic F77™, Pluronic F87™, Pluronic F88™, Pluronic F98™, Pluronic F108™, Pluronic F127™, Pluronic L35™, Tetronic 707™, Tetronic 908™, Tetronic 909™, Tetronic 1107™, Tetronic 1307™, and Tetronic 1508™.

9. The composition of claim 1, 2, 3 or 4 wherein the composition further comprises at least one member selected from the group consisting of a buffering agent, a chelating agent, an osmolality adjusting agent, and a surfactant.

10. The composition of claim 1, 2, 3 or 4 wherein the composition further comprises one or more antimicrobial agents present in an amount effective to disinfect a medical device or preserve a solution.

11. The composition of claim 1, 2 or 3 wherein the composition comprises about 0.1 to about 6.0 weight percent of said two nonionic surfactants and about 0.05 to about 0.5 weight percent of an antimicrobial agent.

12. The composition of claim 4 wherein the composition comprises about 0.1 to about 6.0 weight percent of said poloxamine and poloxamer surfactants and about 0.05 to about 0.5 weight percent of an antimicrobial agent.

13. The composition of claim 1, 2, 3 or 4 wherein the composition further comprises a chelating agent and a buffering agent selected from the group consisting borate buffers, phosphate buffers and citrate buffers.

14. A method of preventing or reducing deposition of lipids on a contact lens while worn on an eye comprising:
soaking prior to placement on an eye said contact lens in an aqueous composition with two nonionic surfactants having a HLB greater than about 18, with the nonionic surfactant having a greater HLB present in an amount about twice that of the nonionic surfactant having a lower HLB, and in an amount effective to prevent or reduce deposition of lipids on said lens while worn on an eye.

15. A method of preventing or reducing deposition of lipids on a contact lens while worn on an eye comprising:
soaking prior to placement on an eye said contact lens in an aqueous composition with two nonionic surfactants having equal HLBs greater than about 18 with the nonionic polyether surfactant having a greater average molecular weight present in an amount about twice that of the nonionic polyether surfactant having a lower average molecular weight, and in an amount effective to prevent or reduce deposition of lipids on said lens while worn on an eye.

16. A method of preventing or reducing deposition of lipids on a contact lens while worn on an eye comprising:
instilling in an eye an aqueous composition with two nonionic surfactants having HLBs greater than about 18 with the nonionic surfactant having a greater HLB present in an amount about twice that of the nonionic surfactant having a lower HLB, and in an amount effective to prevent or reduce deposition of lipids on a contact lens worn in said eye.

17. A method of preventing or reducing deposition of lipids on a contact lens while worn on an eye comprising:
instilling in an eye an aqueous composition with two nonionic surfactants having equal HLBs greater than about 18 with the nonionic surfactant having a greater average molecular weight present in an amount about twice that of the nonionic surfactant having a lower average molecular weight, and in an amount effective to prevent or reduce deposition of lipids on a contact lens worn in said eye.

18. A method of preventing, removing or reducing the amount of lipid deposits on a medical device comprising:
soaking a medical device in an aqueous composition with an effective amount of two nonionic surfactants having a HLB greater than about 18 with the nonionic surfactant having a greater HLB present in an amount about twice that of the nonionic surfactant having a lower HLB to prevent, remove or reduce the amount of lipid deposits on said medical device.

19. A method of preventing, removing or reducing the amount of lipid deposits on a medical device comprising:
soaking a medical device in an aqueous composition with an effective amount of two nonionic surfactants having equal HLBs greater than about 18 with the nonionic surfactant having a greater average molecular weight present in an amount about twice that of the nonionic surfactant having a lower average molecular weight to prevent, remove or reduce the amount of lipid deposits on said medical device.

20. A method of preventing, removing or reducing the amount of lipid deposits on a medical device comprising:
soaking a medical device in an aqueous composition with poloxamine and poloxamer surfactants having HLBs greater than about 18 with said poloxamine surfactant present in an amount about twice that of said poloxamer surfactant, and in an amount effective to prevent, remove or reduce the amount of lipid deposits from a medical device.

21. The method of claim 14, 15, 16, 17, 18, 19 or 20 wherein the aqueous composition includes at least one member selected from the group consisting of an antimicrobial agent, a buffering agent, a chelating agent, an osmolality adjusting agent, and a surfactant.

22. The method of claim 14, 15, 16, 17, 18, 19 or 20 wherein the aqueous composition includes an antimicrobial agent in an amount effective to disinfect a contact lens or preserve a solution.

23. The method of claim 14, 15, 16, 17, 18, 19 or 20 wherein the aqueous composition includes about 0.05 to about 0.5 weight percent of an antimicrobial agent.

24. The method of claim 14, 15, 16, 17, 18, 19 or 20 wherein the aqueous composition includes a chelating agent and a buffering agent selected from the group consisting borate buffers, phosphate buffers and citrate buffers.

25. A method of cleaning a contact lens comprising:
soaking the contact lens in an aqueous composition including two nonionic surfactants having a HLB greater than about 18 with the nonionic polyether surfactant having a greater HLB present in an amount about twice that of the nonionic polyether surfactant having a lower HLB, in an amount effective to reduce or remove lipid deposits from surfaces of a contact lens.

26. The method of claim 25 wherein the lipid deposits are reduced or removed from surfaces of the contact lens without manual rubbing.

27. The method of claim 25 wherein the contact lens is rinsed with said aqueous composition prior to insertion directly into an eye.

28. The method of claim 25 wherein the aqueous composition includes an antimicrobial agent and the contact lens is disinfected while soaked in the aqueous composition.

29. The method of claim 25 wherein the aqueous composition includes an antimicrobial agent present in an amount effective to disinfect the contact lens.

30. The method of claim 14, 15, 16, 17, 18, 19, 20 or 25 wherein said surfactants are selected from the group consisting of Pluronic F38™, Pluronic F68™, Pluronic 68LF ™, Pluronic F77™, Pluronic F87™, Pluronic F88™, Pluronic F98™, Pluronic F108™, Pluronic F127™, Pluronic L35™, Tetronic 707™, Tetronic 908™, Tetronic 909™, Tetronic 1107™, Tetronic 1307™, and Tetronic 1508™.
